(19) United States
(12) Patent Application Publication
(10) Pub. No.: US 2024/0211704 A1
(43) Pub. Date: Jun. 27, 2024

(54) GLOBALIZATION OF VIDEOS USING AUTOMATED VOICE DUBBING

(71) Applicant: Meta Platforms, Inc., Menlo Park, CA (US)

(72) Inventors: Charles Patrick Mason Griffin, Menlo Park, CA (US); Prakash Chandra, Fremont, CA (US); Carlos Lourenco, Dublin, CA (US); Amit Agarwal, Newark, CA (US)

(73) Assignee: Meta Platforms, Inc., Menlo Park, CA (US)

(21) Appl. No.: 18/069,438

(22) Filed: Dec. 21, 2022

(51) Int. Cl. G06F 40/58; G10L 17/20; G10L 19/16

(52) U.S. Cl. CPC G06F 40/58; G10L 17/20; G10L 19/167; G10L 25/57

(57) ABSTRACT

An audio processing system includes: a receiver configured to receive the original audio data; a processor configured to execute the instructions stored in the memory to cause the audio processing system to: separate a background noise audio data, a first speaker audio data, and a second speaker audio data; recognize first speaker speech, convert the first speaker speech to first speaker text, translate the first speaker text to a second language text, and convert the second language text to a second speech; recognize second speaker speech, convert the second speaker speech to second speaker text, translate the second speaker text to the second language text, and convert the second language text of the second speaker to a second speech for the second speaker; and generate encoded audio data; and a transmitter configured to transmit the encoded audio data to a content user device.

### BACKGROUND

Content that is accessible on the Internet is produced all over the world, in all languages. However, there is a fundamental consumption problem—language barriers. Usually viewers are only able to consume content that belongs to the language that they understand. Nevertheless, there is a large inventory of the content available that views would be able consume if only they understood other languages. Currently there are solutions to overcome this barrier by manually translating the content into multiple languages. Currently, this is achieved by hiring human artists and recording their voice in multiple languages. The problem with this approach is, it is very time and money consuming process and does not scale well for multiple languages. What is needed is a system and method for translating videos into multiple audio languages such that anyone is able to access any content in any language.

### SUMMARY OF PARTICULAR CONFIGURATIONS

An aspect of the present disclosure is drawn to an audio processing system for use with a content provider and a content user device. The content provider provides original audio data of a first language, wherein the original audio data includes background noise audio data, first speaker audio data of a first speaker, and second speaker audio data of a second speaker. The audio processing system includes: a memory having instructions stored therein; a processor configured to execute the instructions stored in the memory to cause the audio processing system to: separate the background noise audio data, the first speaker audio data, and the second speaker audio data; translate the first speaker audio language to first speaker audio language of a second language; translate the second speaker audio language to second speaker audio language of a second language; and generate encoded audio data including the first speaker audio language of the second language, the second speaker audio language of the second language, and the background noise audio data; and a transmitter configured to transmit the encoded audio data to the content user device.

Another aspect of the present disclosure is drawn to a method of operating an audio processing system with a content provider and a content user device. The content provider provides original audio data of a first language, the original audio data including background noise audio data, first speaker audio data of a first speaker, and second speaker audio data of a second speaker. The method includes: dividing, via a processor configured to execute instructions stored in a memory, the background noise audio data, the first speaker audio data, and the second speaker audio data; changing, via the processor, the first speaker audio language to first speaker audio language of a second language; changing, via the processor, the second speaker audio language to second speaker audio language of a second language; creating, via the processor, encoded audio data including the first speaker audio data in the second language, the second speaker audio data in the second language, and the background noise audio data; and sending, via a transmitter, the encoded audio data to the content user device.

Another aspect of the present disclosure is drawn to a non-transitory, computer-readable media having computer-readable instructions stored thereon, the computer-readable instructions being capable of being read by an audio processing system for use with a content provider and a content user device. The content provider provides original audio of a first language, the original audio data including background noise audio data, first speaker audio data of a first speaker, and second speaker audio data of a second speaker. The computer-readable instructions are capable of instructing the audio processing system to perform the method including: separating, via a processor configured to execute instructions stored in a memory, the background noise audio data, the first speaker audio data, and the second speaker audio data; changing, via the processor, the first speaker audio language to first speaker audio language of a second language; changing, via the processor, the second speaker audio language to second speaker audio language of a second language; generating, via the processor, encoded audio data including the first speaker audio data in the second language, the second speaker audio data in the second language, and the background noise audio data; and transmitting, via a transmitter, the encoded audio data to the content user device.

### BRIEF DESCRIPTION OF THE DRAWINGS

The various advantages of the configurations will become apparent to one skilled in the art by reading the following specification and appended claims, and by referencing the following drawings, in which:

FIG. 1A illustrates a communication system in accordance with aspects of the present disclosure at a time t₀;

FIG. 1B illustrates the communication system of FIG. 1A at a time t₁;

FIG. 1C illustrates the communication system of FIG. 1A at a time t₂;

FIG. 2 illustrates a method of providing dubbed content in accordance with aspects of the present disclosure;

FIG. 3 illustrates a more detailed block diagram of the content provider, the audio processing system, and the service providing system of FIG. 1A;

FIG. 4 illustrates a method of generating dubbed content from the method of providing dubbed content of FIG. 2;

FIG. 5A illustrates a more detailed block diagram of the speech processor of the audio processing system of FIG. 3 during a first time period processing;

FIG. 5B illustrates a more detailed block diagram of speech processor 316 of audio processing system 104 during a second time period;

FIG. 6 illustrates speaker diarization in accordance with aspects of the present disclosure;

FIG. 7 illustrates a block diagram of an encoding process of the dubbed content in accordance with aspects of the present disclosure;

FIG. 8 illustrates an example look-up table for storage areas with a memory for respective dubbed video content in accordance with aspects of the present disclosure; and

FIG. 9 illustrates an example image of a video snapshot with a dropdown menu of selectable dubbed languages.

### DESCRIPTION OF CONFIGURATIONS

A system and method in accordance with aspects of the present disclosure translates videos into multiple audio languages such that anyone is able to access any content in any language

[symbol]

In accordance with aspects of the present disclosure, any video may be dubbed using an automated machine-learning system. A system and method in accordance with aspects of the present disclosure: 1) receives an input video having original audio data in a first language; 2) transcribes some or all of the speech content using speech to text technology; 3) translates the text into a target language(s) using machine Translations; and 4) converts the translated transcriptions into audio using text to speech technology. The newly created target language audio is overlayed onto the original video to achieve foreign language audio on the original video, aka dubbed video. The entire process is automated and does not require any manual intervention. A system and method in accordance with aspects of the present disclosure also retains background sounds/noise in the original audio, detects speaker changes, and automatically selects the right voice for the right speaker at the right time from the original audio.

In one configuration, a content provider may have a piece of AV content in a first language. For purposes of discussion let the piece of AV content be a romantic comedy movie, wherein all the actors are speaking in English. In accordance with aspects of the present disclosure, the spoken language portions of the audio portion of the AV content are separated. The audio portions are converted to text, in English. The English text is then translated into text of multiple languages, such as a Spanish, German, French, Japanese, etc. Then the text for each language is converted to speech in that respective language. More importantly, the spoken language from each of the actors is the movie separated bases on audio parameters such as pitch, volume, modulation, and style. When the text for each language is converted to speech, each actor is provided with a distinct “voice” based on differentiated pitch, volume, modulation, and style. In this manner, when a person watched the movie in another language, that is different from the original language of the movie, all of the actors will have a distinct voice. Further, the background noise and sounds, can be added back into the translated audio, such that the final translated audio sounds similar to the original audio, with the exception of the new translated spoken language of the actors.

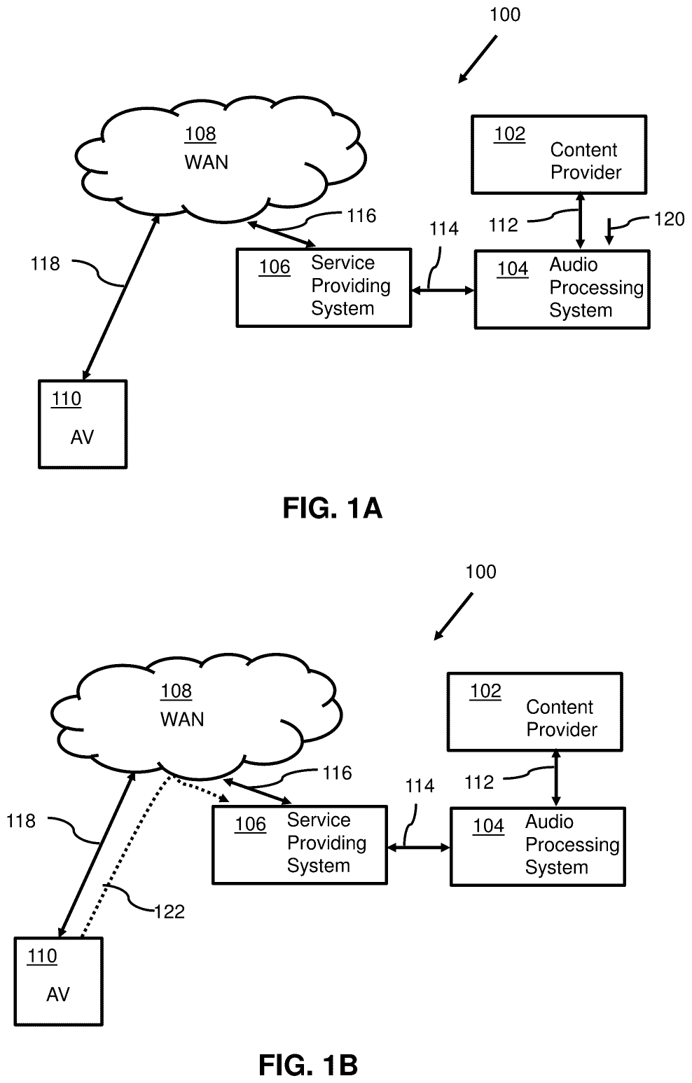

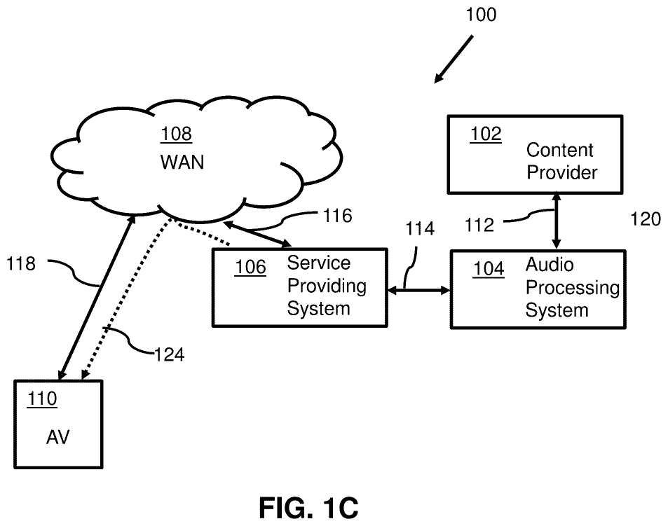

FIG. 1A illustrates a communication system 100 in accordance with aspects of the present disclosure at a time t₀. As shown in the figure, communication system 100 includes a content provider 102, an audio processing system 104, a service providing system 106, a wide area network (WAN) 108 (e.g., the Internet), and an audio video (AV) device 110.

Content provider is arranged and configured to communicate with audio processing system 104 via a communication channel 112. Audio processing system 104 is additionally arranged and configured to communicate with service providing system 106 via a communication channel 114. Service providing system 106 is additionally arranged and configured to communicate with WAN 108 via a communication channel 116. WAN 108 is additionally arranged and configured to communicate with AV device 110 via a communication channel 118.

Content provider 102 may be any device or system that is configured to original audio/video (AV) content. Content provider 102 may include a cable television head end or Internet provider that enables Over-The-Top (OTT) video that provides access to audio and/or video content.

Audio processing system 104 may be any device or system that is configured to process audio data of AV content as provided by content provider 102.

Service providing system 106 may be any device or system that is configured to provide an upstream/downstream service flow for AV device 110 to access content for content provider 102. It should be noted that multiple content providers may provide content to AV device 110 via service providing system 106. However, for purposes of brevity, only a single content provider, content provider 102, is illustrated here.

WAN 108 may be any device or system that is configured to facilitate communication between AV 110 and service providing system 106 through a WAN provider. For purposes of discussion herein, let WAN 108 be the Internet 108.

AV device 110 may be any device or system that is configured to receive and play AV content from service providing system 106. Non-limiting examples of AV device 110 include a television, set-top box, tablet, smart phone, laptop computer and desktop computer.

Each of communication channels 112, 114, 116, and 118 may be any known type of communication channel, non-limiting examples of which include wired and wireless communication channels.

In this example, content provider 102, audio processing system 104 and service providing system 106 are illustrated as distinct items. However, in some configurations, at least two of content provider 102, audio processing system 104 and service providing system 106 may be combined as a unitary item. Further, in some configurations, at least one of content provider 102, audio processing system 104 and service providing system 106 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to, the tangible computer-readable media. In the alternative, the tangible computer-readable media may be integral to the processor. The processor and the tangible computer-readable media may reside in an integrated circuit (IC), an ASIC, or large-scale integrated circuit (LSI), system LSI, super LSI, or ultra-LSI components that perform a part or all of the functions described herein. In the alternative, the processor and the tangible computer-readable media may reside as discrete components.

Example tangible computer-readable media may be also coupled to systems, non-limiting examples of which include a computer system/server, which is operational with numerous other general-purpose or special-purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

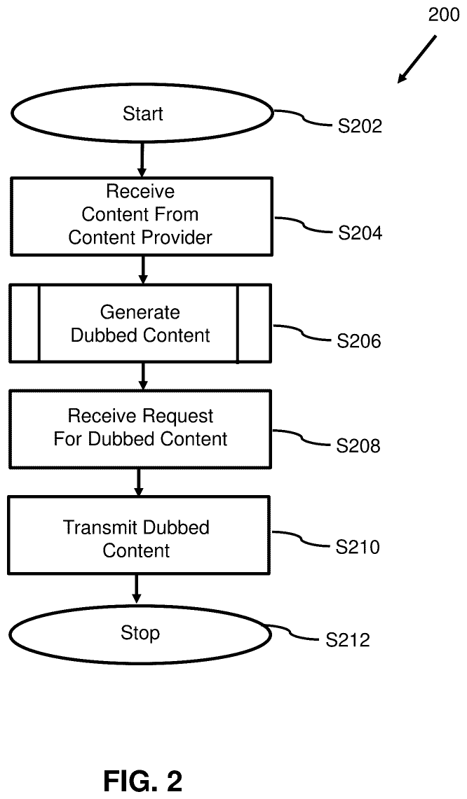

FIG. 2 illustrates a method 200 of providing dubbed content in accordance with aspects of the present disclosure.

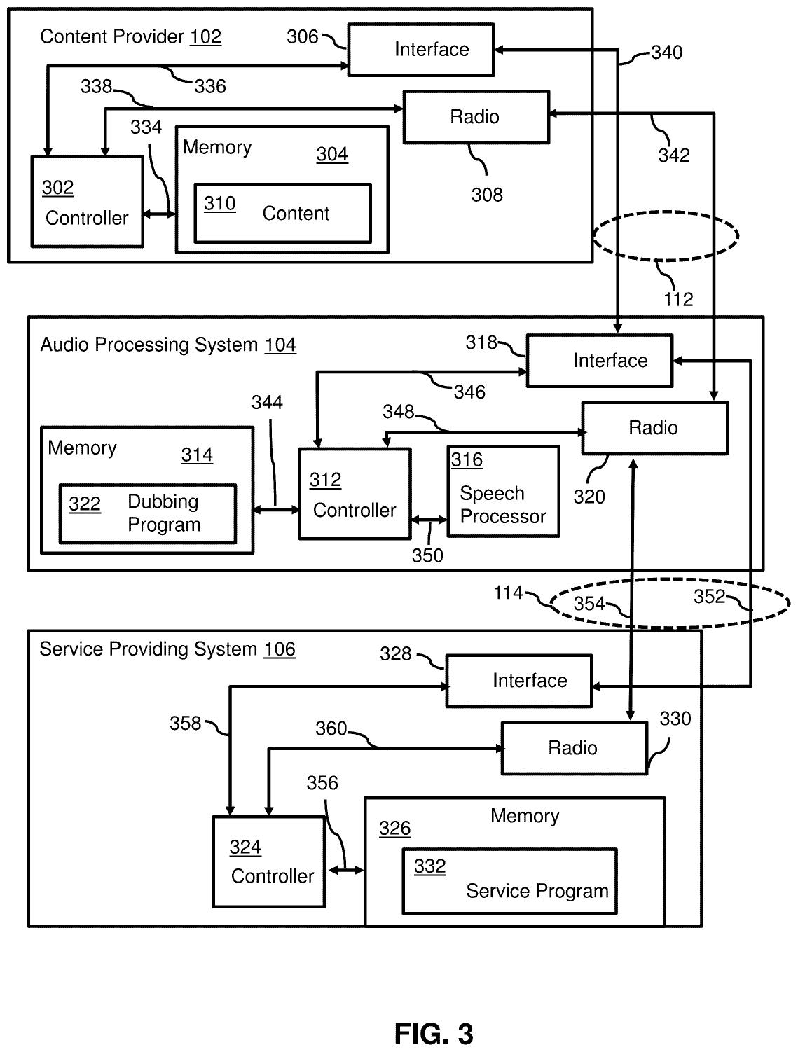

As shown in the figure, method 200 starts (S202) and content is received from a content provider (S204). For example, as shown in FIG. 1A, content provider 102 provides original AV content 120 to audio processing system 104. This will be described in greater detail with reference to FIG. 3.

FIG. 3 illustrates a more detailed block diagram of content provider 102, audio processing system 104, and service providing system 106.

As shown in the figure, content provider 102 includes a controller 302, a memory 304, an interface 306, and a radio 308. Memory 304 has instructions stored therein to be executed by controller 302 and additionally has content 310 stored therein.

Controller 302 may be any device or system that is configured to control general operations of memory 304, interface 306, and radio 308, and includes, but is not limited to, central processing units (CPUs), hardware microprocessors, single-core processors, multi-core processors, field-programmable gate arrays (FPGAs), microcontrollers, application-specific integrated circuits (ASICs), digital signal processors (DSPs), or other similar processing devices capable of executing any type of instructions, algorithms, or software for controlling the operation and functions of memory 304, interface 306, and radio 308.

Memory 304 may be any device or system capable of storing data and instructions used by controller 302, and includes, but is not limited to, random-access memory (RAM), dynamic random-access memory (DRAM), hard drives, solid-state drives, read-only memory (ROM), erasable programmable read-only memory (EPROM), electrically erasable programmable read-only memory (EEPROM), flash memory, embedded memory blocks in FPGAs, or any other various layers of memory hierarchy.

Interface 306 can include one or more connectors, such as RF connectors, or Ethernet connectors that is configured to communicate with known wired communication protocols with interface 318 of audio processing system 104.

Radio 308 may include a Wi-Fi WLAN interface radio transceiver that is operable to communicate with radio 320 of audio processing system 104. Radio 308 may include one or more antennas to communicate wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Radio 308 also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands, RF4CE protocol, ZigBee protocol, Z-Wave protocol, or IEEE 802.15.4 protocol. Further, radio 308 may be equipped with a radio transceiver/wireless communication circuit to implement a cellular connection in accordance with any known transmission techniques, including frequency-division multiple access (FDMA), time-division multiple access (TDMA), and code-division multiple access (CDMA).

Controller 302 is arranged and configured to: communicate with memory 304 via a communication channel 334; communicate with interface 306 via a communication channel 336; and communicate with radio 308 via a communication channel 338.

Each of communication channels 334, 336, and 338 may be any known type of communication channel, non-limiting examples of which include wired and wireless.

In this example, controller 302, memory 304, interface 306, and radio 308 are illustrated as distinct items. However, in some configurations, at least two of controller 302, memory 304, interface 306, and radio 308 may be combined as a unitary item. Further, in some configurations, at least one of controller 302, interface 306, and radio 308 may be implemented as a computer having non-transitory computer-readable media for carrying or having computer-executable instructions or data structures stored thereon.

Audio processing system 104 includes a controller 312, a memory 314, a speech processor 316, an interface 318 and a radio 320. Memory 314 has instructions stored therein to be executed by controller 302 and additionally has a dubbing program 322 stored therein.

Controller 312 may be any device or system that is configured to control general operations of memory 314, interface 318, radio 320, and speech processor 316, and includes, but is not limited to, CPUs, hardware microprocessors, single-core processors, multi-core processors, FPGAs, microcontrollers, ASICs, DSPs, or other similar processing devices capable of executing any type of instructions, algorithms, or software for controlling the operation and functions of memory 314, interface 318, radio 320, and speech processor 316.

Memory 314 may be any device or system capable of storing data and instructions used by controller 312, and includes, but is not limited to, RAM, DRAM, hard drives, solid-state drives, ROM, EPROM, EEPROM, flash memory, embedded memory blocks in FPGAs, or any other various layers of memory hierarchy.

In some configurations, as will be described in greater detail below, dubbing program 322 includes instructions, that when executed by controller 312, cause audio processing system 104 to: separate a background noise audio data, the first speaker audio data, and the second speaker audio data from originally received content; recognize first speaker speech from the first speaker audio data; recognize second speaker speech from the second speaker audio data; convert the recognized first speaker speech from the first speaker audio data to first speaker audio text in the first language; convert the recognized second speaker speech from the second speaker audio data to second speaker audio text in the first language; translate the first speaker audio text in the first language to first speaker audio text in a second language; translate the second speaker audio text in the first language to second speaker audio text in the second language; convert the first speaker audio text in the second language to first speaker audio data in the second language; convert the second speaker audio text in the second language to second speaker audio data in the second language; and generate encoded audio data including the first speaker audio data in the second language, the second speaker audio data in the second language, and the background noise audio data.

In some configurations, as will be described in greater detail below, dubbing program 322 includes instructions, that when executed by controller 312, cause audio processing system 104 to additionally: convert the first speaker audio text in the second language to the first speaker audio data in the second language so as to have a first audio characteristic; and convert the second speaker audio text in the second language to second speaker audio data in the second language so as to have a second audio characteristic that is different from the first audio characteristic. In some of these configurations, as will be described in greater detail below, dubbing program 322 includes instructions, that when executed by controller 312, cause audio processing system 104 to convert the first speaker audio text in the second language to the first speaker audio data in the second language so as to have the first audio characteristic associated with timber.

In some configurations, as will be described in greater detail below, dubbing program 322 includes instructions, that when executed by controller 312, cause audio processing system 104 to additionally: generate first subtitle data corresponding to the first speaker audio data in the second language; and generate second subtitle data corresponding to the second speaker audio data in the second language. In some of these configurations, as will be described in greater detail below, dubbing program 322 includes instructions, that when executed by controller 312, cause audio processing system 104 to additionally generate the encoded audio data to additionally include the first subtitle data and the second subtitle data.

In some configurations, as will be described in greater detail below, dubbing program 322 includes instructions, that when executed by controller 312, cause audio processing system 104 to additionally: translate the first speaker audio text in the first language to first speaker audio text in a third language; translate the second speaker audio text in the first language to second speaker audio text in the third language; convert the first speaker audio text in the third language to first speaker audio data in the third language; convert the second speaker audio text in the third language to second speaker audio data in the third language; and generate the encoded audio data to additionally include the first speaker audio data in the third language and the second speaker audio data in the third language. In some of these configurations, as will be described in greater detail below, dubbing program 322 includes instructions, that when executed by controller 312, cause audio processing system 104 to additionally: generate third subtitle data corresponding to the first speaker audio data in the third language; and generate fourth subtitle data corresponding to the second speaker audio data in the third language.

Interface 318 can include one or more connectors, such as RF connectors, or Ethernet connectors that is configured to communicate with known wired communication protocols with interface 306 of content provider 102 and with interface 328 of service providing system 106.

Radio 320 may include a Wi-Fi WLAN interface radio transceiver that is operable to communicate with radio 308 of content provider 102 and with radio 330 of service providing system 106. Radio 320 may include one or more antennas to communicate wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Radio 308 also be equipped with a radio transceiver/wireless communication circuit to implement a wireless connection in accordance with any Bluetooth protocols, BLE, or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands, RF4CE protocol, ZigBee protocol, Z-Wave protocol, or IEEE 802.15.4 protocol. Further, radio 308 may be equipped with a radio transceiver/wireless communication circuit to implement a cellular connection in accordance with any known transmission techniques, including FDMA, TDMA, and CDMA.

Speech processor 316 may be any device or system that is able to process audio data in accordance with aspects of the present disclosure as will be described in greater detail below, and includes, but is not limited to, CPUs, hardware microprocessors, single-core processors, multi-core processors, FPGAs, microcontrollers, ASICs, DSPs, or other similar processing devices capable of executing any type of instructions, algorithms, or software for processing audio data.

Controller 312 is arranged and configured to: communicate with memory 314 via a communication channel 344; communicate with interface 318 via a communication channel 346; communicate with radio 320 via a communication channel 348; and communicate with speech processor 316 via a communication channel 350.

Each of communication channels 344, 346, 348, and 350 may be any known type of communication channel, non-limiting examples of which include wired and wireless.

In this example, controller 314, memory 314, interface 318, radio 320, and speech processor 316 are illustrated as distinct items. However, in some configurations, at least two of controller 314, memory 314, interface 318, radio 320, and speech processor 316 may be combined as a unitary item. Further, in some configurations, at least one of controller 314, interface 318, radio 320, and speech processor 316 may be implemented as a computer having non-transitory computer-readable media for carrying or having computer-executable instructions or data structures stored thereon.

Service providing system 106 includes a controller 324, a memory 326, an interface 328 and a radio 330. Memory 326 has instructions stored therein to be executed by controller 324 and additionally has a service program 326 stored therein.

Controller 324 may be any device or system that is configured to control general operations of memory 326, interface 328, and radio 330 and includes, but is not limited to, CPUs, hardware microprocessors, single-core processors, multi-core processors, FPGAs, microcontrollers, ASICs, DSPs, or other similar processing devices capable of executing any type of instructions, algorithms, or software for controlling the operation and functions of memory 326, interface 328, and radio 330.

Memory 326 may be any device or system capable of storing data and instructions used by controller 324, and includes, but is not limited to, RAM, DRAM, hard drives, solid-state drives, ROM, EPROM, EEPROM, flash memory, embedded memory blocks in FPGAs, or any other various layers of memory hierarchy

[symbol]

Interface 328 can include one or more connectors, such as RF connectors, or Ethernet connectors that is configured to communicate with known wired communication protocols with interface 318 of audio processing system 104.

Radio 330 may include a Wi-Fi WLAN interface radio transceiver that is operable to communicate with radio 308 of content provider 102. Radio 330 may include one or more antennas to communicate wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Radio 330 also be equipped with a radio transceiver/wireless communication circuit to implement a wireless connection in accordance with any Bluetooth protocols, BLE, or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands, RF4CE protocol, ZigBee protocol, Z-Wave protocol, or IEEE 802.15.4 protocol. Further, radio 330 may be equipped with a radio transceiver/wireless communication circuit to implement a cellular connection in accordance with any known transmission techniques, including FDMA, TDMA, and CDMA.

Controller 324 is arranged and configured to: communicate with memory 326 via a communication channel 356; communicate with interface 328 via a communication channel 358; and communicate with radio 330 via a communication channel 360.

Each of communication channels 356, 358, and 360 may be any known type of communication channel, non-limiting examples of which include wired and wireless.

In this example, controller 324, memory 326, interface 328, and radio 330 are illustrated as distinct items. However, in some configurations, at least two of controller 324, memory 326, interface 328, and radio 330 may be combined as a unitary item. Further, in some configurations, at least one of controller 324, interface 328, and radio 330 may be implemented as a computer having non-transitory computer-readable media for carrying or having computer-executable instructions or data structures stored thereon.

In the event that content provider 102 is configured to communicate with audio processing system 104 through a wired communication channel, then communication channel 112 may include a wired communication channel 340. Wired communication channel 340 may be any known type wired communication channel, non-limiting examples of which include a twisted pair, coaxial, ethernet, and fiber optic. In these configurations, interface 306 of content provider 103 is arranged and configured to communicate with interface 318 of audio processing system 104 via wired communication channel 340.

In the event that content provider 102 is configured to wirelessly communicate with audio processing system 104, then communication channel 112 may include a wireless communication channel 342. Wireless communication channel 342 may be any known type wireless communication channel, non-limiting examples of which include cellular, Wi-Fi and [symbol] . In these configurations, radio 308 of content provider 103 is arranged and configured to communicate with radio 320 of audio processing system 104 via wireless communication channel 342.

In the event that audio processing system 104 is configured to communicate with service providing system 106 through a wired communication channel, then communication channel 114 may include a wired communication channel 352. Wired communication channel 352 may be any known type wired communication channel, non-limiting examples of which include a twisted pair, coaxial, ethernet, and fiber optic. In these configurations, interface 318 of audio processing system 104 is arranged and configured to communicate with interface 328 of service providing system 106 via wired communication channel 352.

In the event that audio processing system 104 is configured to wirelessly communicate with service providing system 106, then communication channel 114 may include a wireless communication channel 354. Wireless communication channel 354 may be any known type wireless communication channel, non-limiting examples of which include cellular and Wi-Fi. In these configurations, radio 320 of audio processing system 104 is arranged and configured to communicate with radio 330 of service providing system 106 via wireless communication channel 354.

In operation, controller 302 of content provider 102 retrieves content from memory 304. For purposes of discussion, let the retrieved content be a movie title, “Mary Had A Big Lamb.” Further, let the movie have multiple actors speaking throughout. Still further, let the content, only have a single language—English—with respect to audio content.

Controller 302 will execute instructions within memory 304 to cause interface 306 to transmit the movie to interface 318 of audio processing system 104 in the case where content provider 102 is configured to communicate with audio processing system 104 via communication channel 340. Controller 302 will execute instructions within memory 304 to cause radio 308 to transmit the movie to radio 320 of audio processing system 104 in the case where content provider 102 is configured to communicate with audio processing system 104 via communication channel 342.

Upon receiving the movie, controller 312 of audio processing system 104 will execute instructions in dubbing program 322 to store the received movie, as original AV content.

It should be noted that the original AV content will be encoded by a known encoding scheme, non-limiting examples of which include the Moving Picture Experts Group (MPEG), H.264, VP9, etc. In any of these encoding schemes, the portions of the data corresponding to sound, i.e., the audio data, may be separated from the portions of the data corresponding to video, i.e., the video data. The separation of audio data from video data is well known and will not be further described for purposes of brevity.

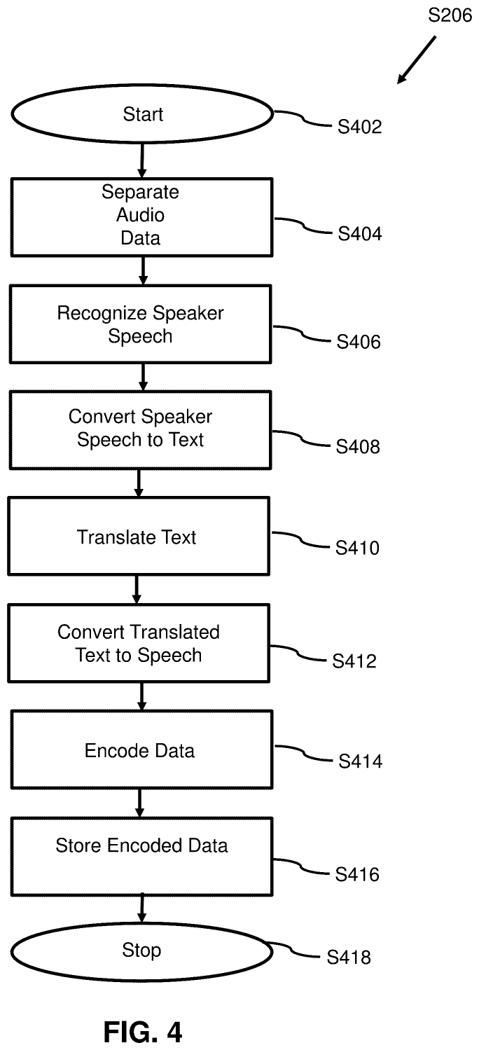

Returning to FIG. 2, after content is received from a content provider (S204), dubbed content is generated (S206). For example, as shown in FIG. 1A, controller 312 of audio processing system 104 executes instructions in dubbing program 322 to cause speech processor 316 to generate dupped content corresponding to the original AV content. This will be described in greater detail with reference to FIG. 4.

FIG. 4 illustrates a method of generating dubbed content (S206) from method 200.

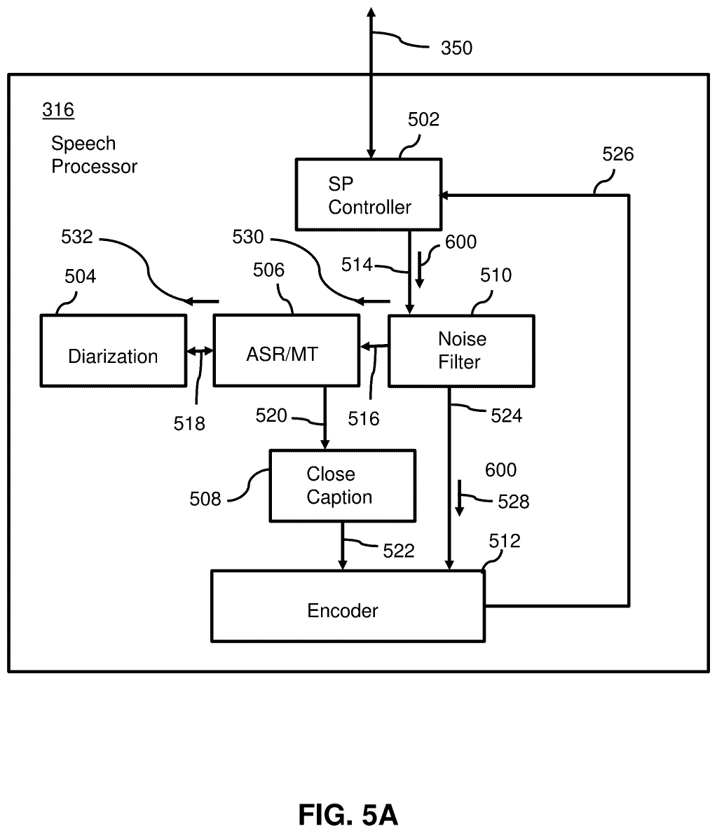

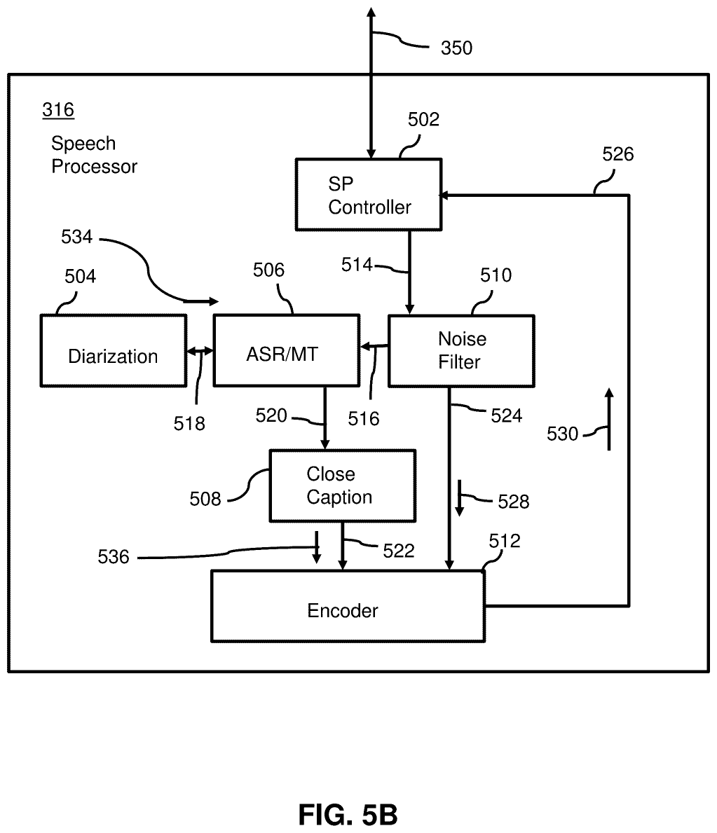

As shown in the figure, the process of generating dupped content (S206) starts (S402), and audio data is separated (S404). For example, as shown in FIG. 3, controller 312 will execute instructions in dubbing program 322 to cause speech processor 316 to separate audio data from the original AV content received from content provider 102. This will be described in greater detail with reference to FIG. 5A.

FIG. 5A illustrates a more detailed block diagram of speech processor 316 of audio processing system 104 during a first time period.

As shown in the figure, speech processor 316 includes a speech processor (SP) controller 502, a diarization processing component 504, an automatic speech recognition and machine translation (ASR/MT) processing component 506, a close caption processing component 508, a noise filter processing component 510, and an encoder 512.

SP controller 502 may be any device or system that is configured to control general operations of diarization processing component 504, ASR/MT processing component 506, close caption processing component 508, noise filter processing component 510, and encoder 512, and includes, but is not limited to, CPUs, hardware microprocessors, single-core processors, multi-core processors, FPGAs, microcontrollers, ASICs, DSPs, or other similar processing devices capable of executing any type of instructions, algorithms, or software for controlling the operation and functions of diarization processing component 504, ASR/MT processing component 506, close caption processing component 508, noise filter processing component 510, and encoder 512.

Diarization processing component 504 may be any processing component that is configured to partition an input audio stream into segments according to speaker identity and includes, but is not limited to, CPUs, hardware microprocessors, single-core processors, multi-core processors, FPGAs, microcontrollers, ASICs, DSPs, or other similar processing devices capable of executing any type of instructions, algorithms, or software to perform such function.

ASR/MT processing component 506 may be any processing component that is configured to recognize speech from an input audio stream and to translate the recognized speech into text and includes, but is not limited to, CPUs, hardware microprocessors, single-core processors, multi-core processors, FPGAs, microcontrollers, ASICs, DSPs, or other similar processing devices capable of executing any type of instructions, algorithms, or software to perform such function.

Close caption processing component 508 may be any processing component that is configured to generate close caption text corresponding to speech text provided by ASR/MT processing component 506 and includes, but is not limited to, CPUs, hardware microprocessors, single-core processors, multi-core processors, FPGAs, microcontrollers, ASICs, DSPs, or other similar processing devices capable of executing any type of instructions, algorithms, or software to perform such function.

Noise filter processing component 510 may be any processing component that is configured to separate background noise/sound from speech within an input audio stream and includes, but is not limited to, CPUs, hardware microprocessors, single-core processors, multi-core processors, FPGAs, microcontrollers, ASICs, DSPs, or other similar processing devices capable of executing any type of instructions, algorithms, or software to perform such function.

Encoder 512 may be any processing component that is configured to encode data provided by diarization processing component 504, ASR/MT processing component 506, close caption processing component 508, and noise filter processing component 510 into an output format that may be used by AV device 110 and includes, but is not limited to, CPUs, hardware microprocessors, single-core processors, multi-core processors, FPGAs, microcontrollers, ASICs, DSPs, or other similar processing devices capable of executing any type of instructions, algorithms, or software to perform such function.

SP controller 502 is arranged and configured to: communicate with controller 312 (not shown) via communication channel 350; communicate with noise filter processing component 510 via a communication channel 514; and communicate with encoder 512 via a communication channel 526.

Noise filter processing component 510 is additionally configured to communicate with ASR/MT processing component 506 via a communication channel 516 and to communicate with encoder 512 via a communication channel 524. ASR/MT processing component 506 is additionally configured to communicate with diarization processing component 504 via a communication channel 518 and to communicate with close caption processing component 508 via a communication channel 520. Close caption processing component 508 is additionally configured to communicate with encoder 512 via a communication channel 522.

Each of communication channels 514, 516, 518, 520, 522, 524, and 526 may be any known type of communication channel, non-limiting examples of which include wired and wireless.

In this example, SP controller 502, diarization processing component 504, ASR/MT processing component 506, close caption processing component 508, noise filter processing component 510, and encoder 512 are illustrated as distinct items. However, in some configurations, at least two of SP controller 502, diarization processing component 504, ASR/MT processing component 506, close caption processing component 508, noise filter processing component 510, and encoder 512 may be combined as a unitary item. Further, in some configurations, at least one of SP controller 502, diarization processing component 504, ASR/MT processing component 506, close caption processing component 508, noise filter processing component 510, and encoder 512 may be implemented as a computer having non-transitory computer-readable media for carrying or having computer-executable instructions or data structures stored thereon.

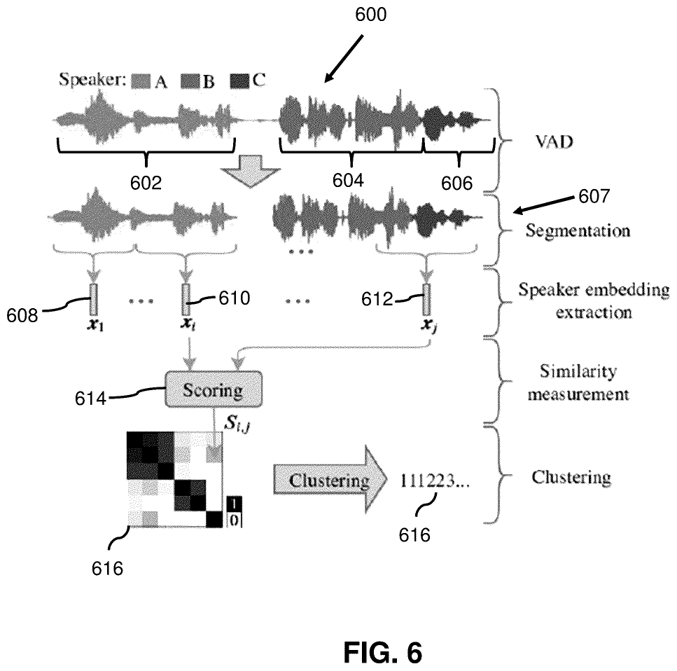

The process of separating the audio data using speech processor 316 will be described in greater detail with additional reference to FIG. 6.

FIG. 6 illustrates speaker diarization in accordance with aspects of the present disclosure. As shown in the figure, original audio content 600 is received by speech processor 316. Original audio content 600 is represented here as an analog signal for purposes of discussion to more easily discuss the operation via figures. It should be noted that original audio content 600 may be a digital signal.

Original audio content 600 includes audio data corresponding to a plurality of speakers and background noise/sound. In this example, a sample of audio data corresponding to three speakers is shown, section 602 corresponds to a speaker A, section 604 corresponds to a speaker B, and section 606 corresponds to a speaker C.

Portion 607 of the figure illustrates original audio content 600 segmented into different portions of speech, such as sentences or phases. As shown in FIG. 5A, SP controller 502 receives the original audio content 600 via communication channel 350 and provides the original audio content 600 to noise filter processing component 510. Noise filter processing component 510 removes background noise/sounds from the original audio content 600 by known methods. This will not be further described for purposes of brevity. Noise filter processing component 510 transmits the filtered background noise/sounds to encoder 512 via communication channel 524 as shown by filtered data arrow 528. As will be discussed below, this filtered background noise/sound will be added back into the dubbed audio data.

Noise filter processing component 510 additionally transmits original audio content 600 without the background noise/sounds, which has been filtered, to ASR/MT processing component 506 as filtered original audio content as shown by arrow 530 via communication channel 516.

ASR/MT processing component 506 then segments the original audio content based on pauses in the speech within the filtered original audio content. The segments of the segmented audio data are represented by item 607 of FIG. 6.

ASR/MT processing component 506 then transmits the segmented speech data to diarization processing component 504 as segmented audio content as shown by arrow 532 via communication channel 518.

Returning to FIG. 4, after audio data is separated (S404), speaker speech is recognized (S406). For example, as shown in FIG. 5A, diarization processing component 504 then assigns the segmented audio content to distinct audio content of speakers A, B, and C. This assignment may be based on parameters of the audio content, non-limiting examples of such parameters include pitch, volume, modulation, and style.

In particular, as shown in FIG. 6, diarization processing component 504 represents each segmented audio content as a vector of n parameters, a sample of such vectors are shown as vectors 608, 610 and 612. Diarization processing component 504 then scores each vector, as shown in processing block 614, for similarity. In some configurations, the similarity may be scored based on a cross-correlation of the vectors.

For example, in this case, vectors 608 and 610 correspond to two phrases spoken by speaker A. As such, both phrases will have a common pitch, volume, modulation, style, etc., as associated with the speech of speaker A. Therefore, vectors 608 and 610 will have a high cross-correlation value. Image 616 is provided to illustrate a cross-correlation between two vectors having n parameters. This is a non-limiting example, as a cross-correlation between n parameter vectors is not feasible.

After all the vectors corresponding to all the audio segments, e.g., phrases, have been cross-correlated with one another, and scored based on the cross-correlation values, diarization processing component 504 then clusters the segments back together as shown in item 616. This cluster of segments therefore recognizes the speech of each speaker.

Returning to FIG. 4, after speaker speech is recognized (S406), the speaker speech is converted to text (S408). This will be described in greater detail with reference to FIG. 5B.

FIG. 5B illustrates a more detailed block diagram of speech processor 316 of audio processing system 104 during a second time period.

As shown in the figure, diarization processing component 504 transmits the clustered segments of audio data to ASR/MT processing component 506, as shown by arrow 534.

ASR/MT processing component 506 then performs machine translation on the audio segments to transform the speech data to text by known methods. These will not be described here for purposes of brevity. However, in accordance with aspects of the present disclosure, the resulting text segments will retain identifiers that identify the specific text segments with the original speakers. In other words, as shown in FIG. 6, the text segments corresponding to the original audio segments derived from section 602 will have an identifier for speaker A, whereas the text segments corresponding to the original audio segments derived from section 604 will have an identifier for speaker B, and the text segments corresponding to the original audio segments derived from section 606 will have an identifier for speaker C, based parameters of the audio content, such parameters include pitch, volume, modulation, and style.

Returning to FIG. 4, after the speaker speech is converted to text (S408), the text is translated (S410). For example, as shown in FIG. 5B, ASR/ML processing component 506 converts the text the text segments corresponding to the original audio segments to speech in a second language. In this example, let the second language be Spanish. In accordance with aspects of the present disclosure, speech processor 316 is not translating the entirety of the original audio content 600 (sans the background noise audio data) as one single piece of audio data. On the contrary, in accordance with aspect of the present disclosure, speech processor 316 translates the distinct segmented audio content, for example as discussed above with respect to segmented audio content 608, 610 and 612. At this point, in this example, the movie Mary Had Large Lamb, has been translated into Spanish text.

Returning to FIG. 4, after the text is translated (S410), the translated text is converted to speech (S412). For example, as shown in FIG. 5B, ASR/MT processing component 506 converts the translated text of the segmented audio content 608, 610, and 610 to speech data as segmented translated audio content. In this example the segmented translated audio content is translated into the speech in the language Spanish. Further, in accordance with aspects of the present disclosure, the speech of each speaker, is differentiated from one another based on the previously determined speech parameters of the audio content, including pitch, volume, modulation, and style.

Returning to FIG. 4, after the translated text is converted to speech (S412), the data is encoded (S414). For example, as shown in FIG. 5B, ASR/ML processing component 506 provides translated speech data to close caption processing component 508. Close caption processing component 508 generates close captions corresponding to the translated speech data. Close caption processing component 508 provides close caption data and the translated speech data to encoder 512 as indicated by arrow 536.

Encoder 512 encodes the translated data and the close caption data as provided by close caption processing component 508 and the background noise/sound data as provided by noise filter 510. In particular, encoder 512 encodes the translated data, the close caption data, and the background noise/sound data into updated translated data, and provides the updated translated data to SP controller 502 as represented by arrow 530.

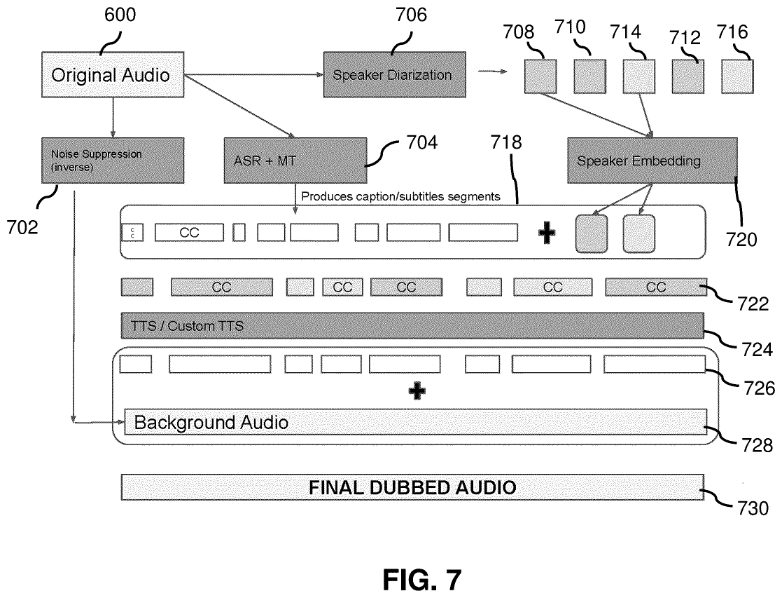

FIG. 7 illustrates a summary block diagram of an encoding process of the dubbed content in accordance with aspects of the present disclosure.

As shown in the figure, original audio content 600 is subjected to speaker noise suppression as shown in block 702, automatic speech recognition/machine conversion as shown in block 704, and speaker diarization as shown in block 706. The process of speaker diarization distinguishes different audio segments from different speakers. For example, in this case, segments 708, 710, and 712 correspond to a first speaker, whereas segments 714 and 716 correspond to a second speaker.

The automatic speech recognition/machine conversion results in converted text segments 718 that are assigned to a particular speaker as provided by the speaker embedding process 720. The converted text segments 718 as embedded with speaker information is closed caption as indicated by close caption indicators 722.

The converted text segments 718 are then translated to a second language as indicated by section 724. The segmented translated segments, as indicated by section 726, are combined with the background audio data 728 to render a final dubbed audio 730.

Returning to FIG. 4, after the data is encoded (S414), the encoded data is stored (S416). For example, as shown in FIG. 3, controller 312 executes instruction in dubbing program 322 to cause audio processing system 104 to store the encoded updated translated data to memory 314.

Returning to FIG. 4, after the encoded data is stored (S416), the process of generating dupped content (S206) stops (S418).

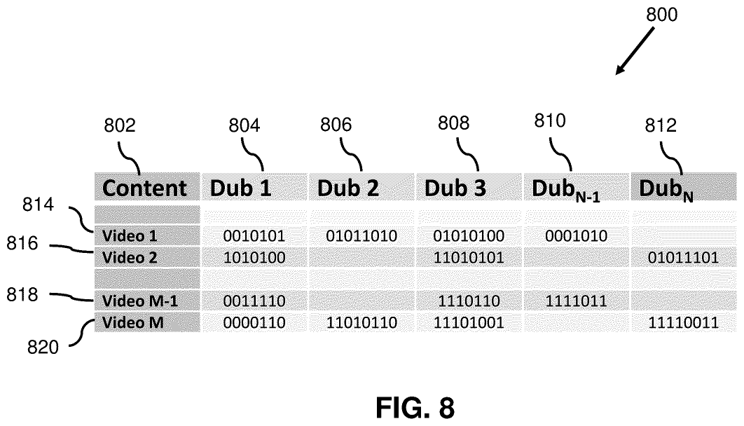

It should be noted that the examples discussed above with reference to FIGS. 2-7 are drawn to storing a single dubbed version in a second language of original AV content in a first language. It should be noted that a system and method in accordance with aspects of the present disclosure may create and store a plurality of versions of original AV content, wherein each version is dubbed in a different language. This will be described in greater detail with reference to FIG. 8.

FIG. 8 illustrates an example look-up table (LUT) 800 for storage areas with memory 314 for respective dubbed video content in accordance with aspects of the present disclosure. As shown in the figure, LUT 800 includes a content column 802, and columns 804, 806, 808, 810, and 812, each corresponding to different dubbed versions, respectively. LUT 800 additionally includes a plurality of rows, a sample of which are indicated as rows 814, 816, 818, and 820, each corresponding to different video content, respectively.

The entries in LUT 800 represent binary memory storage addresses for which a particular content with a particular dubbed language is stored within memory 314 of audio processing system 104. For purposes of discussion, let column 804 (DUB 1) correspond to a dubbed language in Spanish, let row 814 (Video 1) be a movie. As shown in LUT 800, the AV content for the Spanish-dubbed version of the movie is located at memory location 0010101 of memory 314. Further, for purposes of discussion, let column 812 (DUB_{N}) correspond to a dubbed language in Urdu. In this example, the movie of row 814 has no Urdu dubbed version.

Therefore, in accordance with aspects of the present disclosure, any number of versions of original content may be automatically created and stored for future access by a user. Further, each version that is dubbed in a different respective language, will automatically include differently sounding voice-overs corresponding to the respective different original voices.

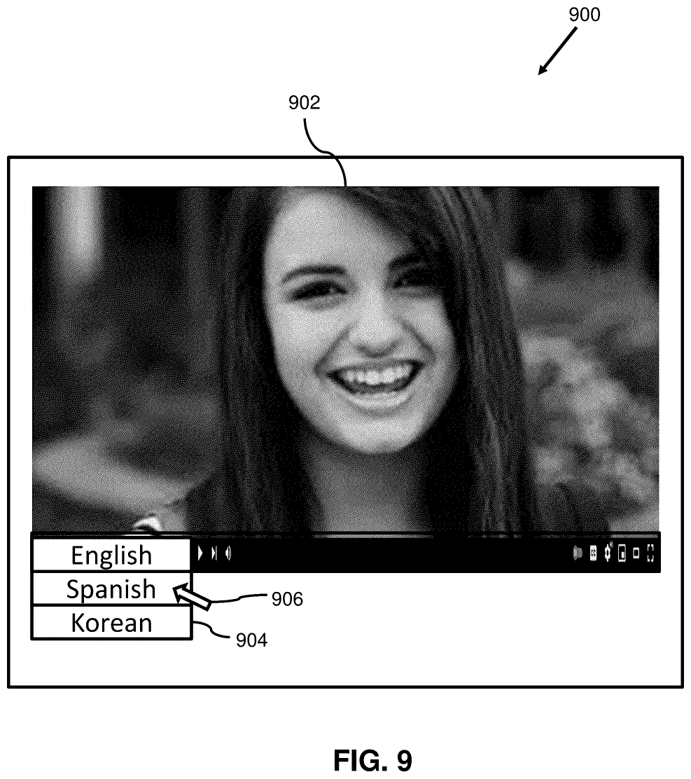

Returning to FIG. 2, after dubbed content is generated (S206), a request for dubbed content is received (S208). For example, as shown in FIG. 1B, a user of AV device 110 may request to view content in a particular language, as shown by arrow 122. This will be described in greater detail with reference to FIG. 9.

FIG. 9 illustrates an example image 900 of a video snapshot 902 with a dropdown menu 904 of selectable dubbed languages, in accordance with aspects of the present disclosure.

For purposes of discussion, let a user choose a dubbed version of the video corresponding to video snapshot 902 in Spanish. This may be accomplished by placing a pointer 906 and double clicking the “Spanish” option in dropdown menu 904. This request will be further described with reference to FIG. 1B.

FIG. 1B illustrates communication system 100 at a time t₁. As shown in the figure, AV device 110 transmits a request 122 to service providing system 106 to provide the version of the video corresponding to video snapshot 902 in Spanish.

In response, service providing system 106 retrieves a copy of the Spanish-dubbed version of the video corresponding to the video snapshot 902 from memory 314. In particular, as mentioned above, the Spanish-dubbed version of the video corresponding to the video snapshot 902 will have been created and stored in memory 314 of audio processing system 104 in accordance with the process discussed above with reference to FIG. 4.

Returning to FIG. 2, after a request for dupped content is received (S208), dubbed content is transmitted (S210). For example, as shown in FIG. 1C, service providing system 106 will transmit the AV data of the Spanish-dubbed version of the video corresponding to the video snapshot 902. More specifically, as mentioned above, audio processing system 104 will access AV data of the Spanish-dubbed version of the video corresponding to the video snapshot 902 as stored in memory 314 and provide the Spanish-dubbed version of the video corresponding to the video snapshot 902 to service providing system 106. Service providing system 106 will then provide the Spanish-dubbed version of the video corresponding to the video snapshot 902 to AV device 110 as shown by arrow 124.

Returning to FIG. 2, after dubbed content is transmitted (S210), method 200 stops (S212).

A problem with prior art content providing systems, such as cable providers, over-the top content providers, etc., is that some content does not have audio in a language for which a user might be able to understand. While translating software might enable a user to understand the audio content, prior art translating software does not take into account different speakers within a single piece of AV content. The problem with majority of the Audio/Video content today is that the viewer must understand the language for which the content is provided. Certain software solutions try to overcome this problem by directly translating the audio into another language, but all prior art software lose all the details in this process, like background sound, multiple speakers with different gender/age/pitch, etc.

In accordance with aspects of the present disclosure, the audio portion of a piece of AV content may be automatically translated into multiple languages. Further, the audio portion of each individual speaker retains a sense of individuality when translated. As such, a user listening to any translated version will be able to distinguish the different speakers in the translated version of the content.

### EXAMPLES

An aspect of the present disclosure is drawn to an audio processing system for use with a content provider and a content user device. The content provider provides original audio data of a first language, wherein the original audio data includes background noise audio data, first speaker audio data of a first speaker, and second speaker audio data of a second speaker. The audio processing system includes: a memory having instructions stored therein; a processor configured to execute the instructions stored in the memory to cause the audio processing system to: separate the background noise audio data, the first speaker audio data, and the second speaker audio data; translate the first speaker audio language to first speaker audio language of a second language; translate the second speaker audio language to second speaker audio language of a second language; and generate encoded audio data including the first speaker audio language of the second language, the second speaker audio language of the second language, and the background noise audio data; and a transmitter configured to transmit the encoded audio data to the content user device.

In some configurations of this aspect, the processor is configured to execute the instructions stored in the memory to additionally cause the audio processing system to: recognize first speaker speech from the first speaker audio data; recognize second speaker speech from the second speaker audio data; convert the recognized first speaker speech from the first speaker audio data to first speaker audio text in the first language; convert the recognized second speaker speech from the second speaker audio data to second speaker audio text in the first language; translate the first speaker audio text in the first language to first speaker audio text in a second language; translate the second speaker audio text in the first language to second speaker audio text in the second language; convert the first speaker audio text in the second language to first speaker audio data in the second language; and convert the second speaker audio text in the second language to second speaker audio data in the second language.

In some configurations of this aspect, the processor is configured to execute the instructions stored in the memory to additionally cause the audio processing system to: convert the first speaker audio text in the second language to the first speaker audio data in the second language so as to have a first audio characteristic; and convert the second speaker audio text in the second language to second speaker audio data in the second language so as to have a second audio characteristic that is different from the first audio characteristic.

In some configurations of this aspect, the processor is configured to execute the instructions stored in the memory to additionally cause the audio processing system to convert the first speaker audio text in the second language to the first speaker audio data in the second language so as to have the first audio characteristic associated with timber.

In some configurations of this aspect, the processor is configured to execute the instructions stored in the memory to additionally cause the audio processing system to: generate first subtitle data corresponding to the first speaker audio data in the second language; and generate second subtitle data corresponding to the second speaker audio data in the second language.

In some configurations of this aspect, the processor is configured to execute the instructions stored in the memory to additionally cause the audio processing system to generate the encoded audio data to additionally include the first subtitle data and the second subtitle data.

In some configurations of this aspect, the processor is configured to execute the instructions stored in the memory to additionally cause the audio processing system to: translate the first speaker audio text in the first language to first speaker audio text in a third language; translate the second speaker audio text in the first language to second speaker audio text in the third language; convert the first speaker audio text in the third language to first speaker audio data in the third language; convert the second speaker audio text in the third language to second speaker audio data in the third language; and generate the encoded audio data to additionally include the first speaker audio data in the third language and the second speaker audio data in the third language.

Another aspect of the present disclosure is drawn to a method of operating an audio processing system with a content provider and a content user device. The content provider provides original audio data of a first language, the original audio data including background noise audio data, first speaker audio data of a first speaker, and second speaker audio data of a second speaker. The method includes: dividing, via a processor configured to execute instructions stored in a memory, the background noise audio data, the first speaker audio data, and the second speaker audio data; changing, via the processor, the first speaker audio language to first speaker audio language of a second language; changing, via the processor, the second speaker audio language to second speaker audio language of a second language; creating, via the processor, encoded audio data including the first speaker audio data in the second language, the second speaker audio data in the second language, and the background noise audio data; and sending, via a transmitter, the encoded audio data to the content user device.

In some configurations of this aspect, the method further includes: recognizing, via the processor, first speaker speech from the first speaker audio data; recognizing, via the processor, second speaker speech from the second speaker audio data; converting, via the processor, the recognized first speaker speech from the first speaker audio data to first speaker audio text in the first language; converting, via the processor, the recognized second speaker speech from the second speaker audio data to second speaker audio text in the first language; changing, via the processor, the first speaker audio text in the first language to first speaker audio text in a second language; changing, via the processor, the second speaker audio text in the first language to second speaker audio text in the second language; converting, via the processor, the first speaker audio text in the second language to first speaker audio data in the second language; and converting, via the processor, the second speaker audio text in the second language to second speaker audio data in the second language.

In some configurations of this aspect, the converting, via the processor, the first speaker audio text in the second language to the first speaker audio data in the second language includes converting the first speaker audio text in the second language to the first speaker audio data in the second language so as to have a first audio characteristic, and the converting, via the processor, the second speaker audio text in the second language to the second speaker audio data in the second language includes converting the second speaker audio text in the second language to the second speaker audio data in the second language so as to have a second audio characteristic that is different from the first audio characteristic.

In some configurations of this aspect, the converting the first speaker audio text in the second language to the first speaker audio data in the second language so as to have a first audio characteristic includes converting the first speaker audio text in the second language to the first speaker audio data in the second language so as to have the first audio characteristic associated with timber.

In some configurations of this aspect, the method further includes: creating, via the processor, first subtitle data corresponding to the first speaker audio data in the second language; and creating, via the processor, second subtitle data corresponding to the second speaker audio data in the second language

[symbol]

In some configurations of this aspect, the method further includes: creating, via the processor, the encoded audio data to additionally include the first subtitle data and the second subtitle data.

In some configurations of this aspect, the method further includes: changing, via the processor, the first speaker audio text in the first language to first speaker audio text in a third language; changing, via the processor, the second speaker audio text in the first language to second speaker audio text in the third language; converting, via the processor, the first speaker audio text in the third language to first speaker audio data in the third language; converting, via the processor, the second speaker audio text in the third language to second speaker audio data in the third language; and creating, via the processor, the encoded audio data to additionally include the first speaker audio data in the third language and the second speaker audio data in the third language.

Another aspect of the present disclosure is drawn to a non-transitory, computer-readable media having computer-readable instructions stored thereon, the computer-readable instructions being capable of being read by an audio processing system for use with a content provider and a content user device. The content provider provides original audio of a first language, the original audio data including background noise audio data, first speaker audio data of a first speaker, and second speaker audio data of a second speaker. The computer-readable instructions are capable of instructing the audio processing system to perform the method including: separating, via a processor configured to execute instructions stored in a memory, the background noise audio data, the first speaker audio data, and the second speaker audio data; changing, via the processor, the first speaker audio language to first speaker audio language of a second language; changing, via the processor, the second speaker audio language to second speaker audio language of a second language; generating, via the processor, encoded audio data including the first speaker audio data in the second language, the second speaker audio data in the second language, and the background noise audio data; and transmitting, via a transmitter, the encoded audio data to the content user device.

In some configurations of this aspect, the computer-readable instructions are capable of instructing the audio processing system to perform the method further including: recognizing, via the processor, first speaker speech from the first speaker audio data; recognizing, via the processor, second speaker speech from the second speaker audio data; converting, via the processor, the recognized first speaker speech from the first speaker audio data to first speaker audio text in the first language; converting, via the processor, the recognized second speaker speech from the second speaker audio data to second speaker audio text in the first language; changing, via the processor, the first speaker audio text in the first language to first speaker audio text in a second language; changing, via the processor, the second speaker audio text in the first language to second speaker audio text in the second language; converting, via the processor, the first speaker audio text in the second language to first speaker audio data in the second language; and converting, via the processor, the second speaker audio text in the second language to second speaker audio data in the second language.

In some configurations of this aspect, the computer-readable instructions are capable of instructing the audio processing system to perform the method wherein the converting, via the processor, the first speaker audio text in the second language to the first speaker audio data in the second language includes converting the first speaker audio text in the second language to the first speaker audio data in the second language so as to have a first audio characteristic, and wherein the converting, via the processor, the second speaker audio text in the second language to the second speaker audio data in the second language includes converting the second speaker audio text in the second language to the second speaker audio data in the second language so as to have a second audio characteristic that is different from the first audio characteristic.

In some configurations of this aspect, the computer-readable instructions are capable of instructing the audio processing system to perform the method wherein the converting the first speaker audio text in the second language to the first speaker audio data in the second language so as to have a first audio characteristic includes converting the first speaker audio text in the second language to the first speaker audio data in the second language so as to have the first audio characteristic associated with timber.

In some configurations of this aspect, the computer-readable instructions are capable of instructing the audio processing system to perform the method further including: generating, via the processor, first subtitle data corresponding to the first speaker audio data in the second language; and generating, via the processor, second subtitle data corresponding to the second speaker audio data in the second language

[symbol]

In some configurations of this aspect, the computer-readable instructions are capable of instructing the audio processing system to perform the method further including generating, via the processor, the encoded audio data to additionally include the first subtitle data and the second subtitle data.

Some or all aspects of audio processing system 104 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of audio processing system 104 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of audio processing system can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Those skilled in the art will appreciate from the foregoing description that the broad techniques of the configurations can be implemented in a variety of forms. Therefore, while the configurations have been described in connection with particular examples thereof, the true scope of the configurations should not be so limited since other modifications will become apparent to the skilled practitioner upon a study of the drawings, specification, and following claims.

What is claimed is:

1. An audio processing system for use with a content provider and a content user device, the content provider providing original audio data of a first language, the original audio data including background noise audio data, first speaker audio data of a first speaker, and second speaker audio data of a second speaker, said audio processing system comprising:
a memory having instructions stored therein;
a processor configured to execute the instructions stored in the memory to cause the audio processing system to:
separate the background noise audio data, the first speaker audio data, and the second speaker audio data;
translate first speaker audio language to first speaker audio language of a second language;
translate the second speaker audio language to second speaker audio language of a second language; and
generate encoded audio data including the first speaker audio language of the second language, the second speaker audio language of the second language, and the background noise audio data; and
a transmitter configured to transmit the encoded audio data to the content user device.

2. The audio processing system of claim 1, wherein said processor is configured to execute the instructions stored in the memory to additionally cause the audio processing system to:
recognize first speaker speech from the first speaker audio data;
recognize second speaker speech from the second speaker audio data;
convert the recognized first speaker speech from the first speaker audio data to first speaker audio text in the first language;
convert the recognized second speaker speech from the second speaker audio data to second speaker audio text in the first language;
translate the first speaker audio text in the first language to first speaker audio text in a second language;
translate the second speaker audio text in the first language to second speaker audio text in the second language;
convert the first speaker audio text in the second language to first speaker audio data in the second language; and
convert the second speaker audio text in the second language to second speaker audio data in the second language.

3. The audio processing system of claim 2, wherein said processor is configured to execute the instructions stored in the memory to additionally cause the audio processing system to:
convert the first speaker audio text in the second language to the first speaker audio data in the second language so as to have a first audio characteristic; and
convert the second speaker audio text in the second language to second speaker audio data in the second language so as to have a second audio characteristic that is different from the first audio characteristic.

4. The audio processing system of claim 3, wherein said processor is configured to execute the instructions stored in the memory to additionally cause the audio processing system to convert the first speaker audio text in the second language to the first speaker audio data in the second language so as to have the first audio characteristic associated with timber.

5. The audio processing system of claim 2, wherein said processor is configured to execute the instructions stored in the memory to additionally cause the audio processing system to:
generate first subtitle data corresponding to the first speaker audio data in the second language; and
generate second subtitle data corresponding to the second speaker audio data in the second language.

6. The audio processing system of claim 5, wherein said processor is configured to execute the instructions stored in the memory to additionally cause the audio processing system to generate the encoded audio data to additionally include the first subtitle data and the second subtitle data.

7. The audio processing system of claim 2, wherein said processor is configured to execute the instructions stored in the memory to additionally cause the audio processing system to:
translate the first speaker audio text in the first language to first speaker audio text in a third language;
translate the second speaker audio text in the first language to second speaker audio text in the third language;
convert the first speaker audio text in the third language to first speaker audio data in the third language;
convert the second speaker audio text in the third language to second speaker audio data in the third language; and
generate the encoded audio data to additionally include the first speaker audio data in the third language and the second speaker audio data in the third language.

8. A method of operating an audio processing system with a content provider and a content user device, the content provider providing original audio data of a first language, the original audio data including background noise audio data, first speaker audio data of a first speaker, and second speaker audio data of a second speaker, said method comprising:
dividing, via a processor configured to execute instructions stored in a memory, the background noise audio data, the first speaker audio data, and the second speaker audio data;
changing, via the processor, first speaker audio language to first speaker audio language of a second language;
changing, via the processor, the second speaker audio language to second speaker audio language of a second language;
creating, via the processor, encoded audio data including the first speaker audio data in the second language, the second speaker audio data in the second language, and the background noise audio data; and
sending, via a transmitter, the encoded audio data to the content user device.

9. The method of claim 8, further comprising:
recognizing, via the processor, first speaker speech from the first speaker audio data;
recognizing, via the processor, second speaker speech from the second speaker audio data;
converting, via the processor, the recognized first speaker speech from the first speaker audio data to first speaker audio text in the first language;
converting, via the processor, the recognized second speaker speech from the second speaker audio data to second speaker audio text in the first language;
changing, via the processor, the first speaker audio text in the first language to first speaker audio text in a second language;
changing, via the processor, the second speaker audio text in the first language to second speaker audio text in the second language;
converting, via the processor, the first speaker audio text in the second language to first speaker audio data in the second language; and
converting, via the processor, the second speaker audio text in the second language to second speaker audio data in the second language.

10. The method of claim 9,
wherein said converting, via the processor, the first speaker audio text in the second language to the first speaker audio data in the second language comprises converting the first speaker audio text in the second language to the first speaker audio data in the second language so as to have a first audio characteristic, and
wherein said converting, via the processor, the second speaker audio text in the second language to the second speaker audio data in the second language comprises converting the second speaker audio text in the second language to the second speaker audio data in the second language so as to have a second audio characteristic that is different from the first audio characteristic.

11. The method of claim 10, wherein said converting the first speaker audio text in the second language to the first speaker audio data in the second language so as to have a first audio characteristic comprises converting the first speaker audio text in the second language to the first speaker audio data in the second language so as to have the first audio characteristic associated with timber.

12. The method of claim 9, further comprising:
creating, via the processor, first subtitle data corresponding to the first speaker audio data in the second language; and
creating, via the processor, second subtitle data corresponding to the second speaker audio data in the second language.

13. The method of claim 12, further comprising creating, via the processor, the encoded audio data to additionally include the first subtitle data and the second subtitle data.

14. The method of claim 9, further comprising:
changing, via the processor, the first speaker audio text in the first language to first speaker audio text in a third language;
changing, via the processor, the second speaker audio text in the first language to second speaker audio text in the third language;
converting, via the processor, the first speaker audio text in the third language to first speaker audio data in the third language;
converting, via the processor, the second speaker audio text in the third language to second speaker audio data in the third language; and
creating, via the processor, the encoded audio data to additionally include the first speaker audio data in the third language and the second speaker audio data in the third language.

15. A non-transitory, computer-readable media having computer-readable instructions stored thereon, the computer-readable instructions being capable of being read by an audio processing system for use with a content provider and a content user device, the content provider providing original audio of a first language, the original audio data including background noise audio data, first speaker audio data of a first speaker, and second speaker audio data of a second speaker, wherein the computer-readable instructions are capable of instructing the audio processing system to perform the method comprising:
separating, via a processor configured to execute instructions stored in a memory, the background noise audio data, the first speaker audio data, and the second speaker audio data;
changing, via the processor, first speaker audio language to first speaker audio language of a second language;
changing, via the processor, the second speaker audio language to second speaker audio language of a second language;
generating, via the processor, encoded audio data including the first speaker audio data in the second language, the second speaker audio data in the second language, and the background noise audio data; and
transmitting, via a transmitter, the encoded audio data to the content user device.

16. The non-transitory, computer-readable media of claim 15, wherein the computer-readable instructions are capable of instructing the audio processing system to perform the method further comprising:
recognizing, via the processor, first speaker speech from the first speaker audio data;
recognizing, via the processor, second speaker speech from the second speaker audio data;
converting, via the processor, the recognized first speaker speech from the first speaker audio data to first speaker audio text in the first language;
converting, via the processor, the recognized second speaker speech from the second speaker audio data to second speaker audio text in the first language;
changing, via the processor, the first speaker audio text in the first language to first speaker audio text in a second language;
changing, via the processor, the second speaker audio text in the first language to second speaker audio text in the second language;
converting, via the processor, the first speaker audio text in the second language to first speaker audio data in the second language; and
converting, via the processor, the second speaker audio text in the second language to second speaker audio data in the second language.

17. The non-transitory, computer-readable media of claim 16, wherein the computer-readable instructions are capable of instructing the audio processing system to perform the method
wherein said converting, via the processor, the first speaker audio text in the second language to the first speaker audio data in the second language comprises converting the first speaker audio text in the second language to the first speaker audio data in the second language so as to have a first audio characteristic, and
wherein said converting, via the processor, the second speaker audio text in the second language to the second speaker audio data in the second language comprises converting the second speaker audio text in the second language to the second speaker audio data in the second language so as to have a second audio characteristic that is different from the first audio characteristic.

18. The non-transitory, computer-readable media of claim 17, wherein the computer-readable instructions are capable of instructing the audio processing system to perform the method wherein said converting the first speaker audio text in the second language to the first speaker audio data in the second language so as to have a first audio characteristic comprises converting the first speaker audio text in the second language to the first speaker audio data in the second language so as to have the first audio characteristic associated with timber.

19. The non-transitory, computer-readable media of claim 16, wherein the computer-readable instructions are capable of instructing the audio processing system to perform the method further comprising:
generating, via the processor, first subtitle data corresponding to the first speaker audio data in the second language; and
generating, via the processor, second subtitle data corresponding to the second speaker audio data in the second language.

20. The non-transitory, computer-readable media of claim 19, wherein the computer-readable instructions are capable of instructing the audio processing system to perform the method further comprising generating, via the processor, the encoded audio data to additionally include the first subtitle data and the second subtitle data.
